(19) United States
(12) Patent Application Publication
(10) Pub. No.: US 2011/0060770 A1
(43) Pub. Date: Mar. 10, 2011

(54) METHOD AND DISPLAY MODULE FOR PROVIDING A USER CONTROL ELEMENT WITHIN A COMPUTER-ASSISTED DATA ORGANIZATION AND STORAGE SYSTEM

(76) Inventor: Michael GÖBEL, Uttenreuth (DE)

(21) Appl. No.: 12/877,641

(22) Filed: Sep. 8, 2010

(30) Foreign Application Priority Data
Sep. 10, 2009 (DE) 10 2009 040 913.0

(51) Int. Cl. G06F 17/30

(52) U.S. Cl. 707/805; 707/E17.005

(57) ABSTRACT

A method and a display module are disclosed for providing a user control element within a computer-assisted data organization and storage system. In at least one embodiment, the functionality of the user control element is dynamically linked to the context and/or semantics or an active selection element. In at least one embodiment, a selection is made of at least one selection element from a plurality of available selection elements and the functionality linked to the active, selected selection element is used by triggering the user control element.

### PRIORITY STATEMENT

The present application hereby claims priority under 35 U.S.C. §119 on German patent application number DE 10 2009 040 913.0 filed Sep. 10, 2009, the entire contents of which are hereby incorporated herein by reference.

### FIELD

At least one embodiment of the invention generally relates to a method and a display module including at least one device for providing a user control element within a computer-assisted data organization and storage system.

### BACKGROUND

In order to be able to efficiently assess complex processes, adequate preparation and presentation of all relevant data is essential. In addition to a good overview, rapid access to detailed information is also necessary. The aim is to configure this in a user-friendly fashion.

The tabular form is used ever more frequently as a structure element for representing information. It is used both in individual products (standalone and/or web-based) and also in general tools (e.g. MS Excel). Here allowance is made for the requirements of the user by providing a large number of integrated and/or configurable control elements with functionalities such as sorting, filtering, detailed views for instance. In many cases, individual adjustments can be combined to form so-called macros, which can if necessary be triggered by way of a button or short cut.

The number of necessary control elements is nevertheless high in this way. Numerous buttons complicates the clear arrangement of the user interface, while the functionalities are not used and/or incorrectly applied as a result of short cuts which have been forgotten or incorrectly input by the user.

### SUMMARY

In at least one embodiment of the present invention, the procedure of the afore-cited type is configured and improved in a user-friendly fashion.

In at least one embodiment, a method and an apparatus are disclosed. Advantageous embodiments of the method and the apparatus form the subject matter of the dependent claims or can be inferred from the subsequent description and the example embodiments.

One aspect of at least one embodiment of the invention is a method for providing a user control element within a computer-assisted data organization and storage system, with the functionality of the user control element being dynamically linked to the context and/or the semantics of an active selection element. Further, in at least one embodiment, a selection of at least one selection element is made from a plurality of available selection elements and a use of the functionality which is linked to the active, selected selection element is made by triggering the user control element.

A further aspect of at least one embodiment of the invention includes at least one device comprising a display module for providing a user control element within a computer-assisted data organization and storage system, with the functionality of the user control element being dynamically linked to the context and/or semantics of an active selection element, further including at least one device for selecting at least one selection element from a plurality of available selection elements and means for using the functionality linked to the active, selected selection element by triggering the user control element.

The functionality preferably includes a filtering and/or sorting and/or fading-in of additional information and/or activation of assigned applications. The functionality can also include an optical display (e.g. color, “bold”, “italics” etc.) of relevant data.

The functionality which is to be executed in detail is decided by the user by way of the context and semantics of the active selection element, i.e. a tabular element, which contains the cursor C and/or is selected by the cursor C.

The context relates to the relationship in which the active selection element exists, e.g. one or several elements of the line and/or column heading. The semantics relates to the meaning of the content of the active selection element, i.e. numerical digits can be sorted in ascending/descending order. Text entries can be filtered in terms of content.

Expediently, a data organization and/or storage system can be represented by a data list and/or table or a database and/or archiving system.

The use of numerous buttons and/or keyboard shortcuts can be omitted by way of polymorphism within a user interface. The operation is more clearly arranged, since the control is carried out with the mouse and the execution is triggered with a single button/shortcut. Furthermore, the long-winded and error-prone inputting of complex settings is superfluous.

The operation is more efficient since the functionality (e.g. filtering) is already installed. The functionality is always available, which appears to measure the focused tabular element. The operation is more intuitive, since the functionality (e.g. status change) emerges directly from the focused tabular element. The power of the method can be almost unrestrictedly extended by embedding user-specific macros. The operation is more flexible since the functionality can be adjusted to the respective requirements of the user.

### BRIEF DESCRIPTION OF THE DRAWINGS

Further advantages, details and developments of the invention result from the subsequent description of example embodiments in conjunction with the drawings, in which;

FIGS. 1a and 1b show by way of example a data organization form with the aid of the tool “MS Excel”,

FIG. 2 shows by way of example a data organization in a medical environment and

FIG. 3 shows exemplary data according to the use of an embodiment of the invention in a time-critical manner (table head), followed by ‘version’=“VA10A_IT48” (table cell).

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In accordance with an embodiment of the invention, a single control element is used, the functionality of which is dynamically produced as a function of the selected tabular element (polymorphism).

The Activation of a Functionality is Thus Two-Stage:

in a first step, the cursor C is entered into a table cell,

while in a second step, the functionality linked to the selected cell is executed by triggering the control element. This can be implemented for instance by triggering and/or starting a so-called macro.

Individual elements of the table head can preferably be stored with column-dependent sorting and filtering functions, while the respective table cell itself allows access to the detailed information relating to this entry. The functionality which is to be executed in detail is decided by the user by means of the context and semantics of the active tabular element, i.e. which contains the cursor and/or is selected by said cursor. This can extend from a simple “filtering of all entries according to several criteria” via a “fading-in of additional information” to “starting, an assigned application”.

Although an embodiment of the invention can also be transferred to other data organization forms, e.g. database systems and is here in no way only restricted to general tools, the procedure is explained on the basis of an example in respect of the control of ongoing processes with the aid of the tool in the form of a data list and/or table ‘MS Excel’.

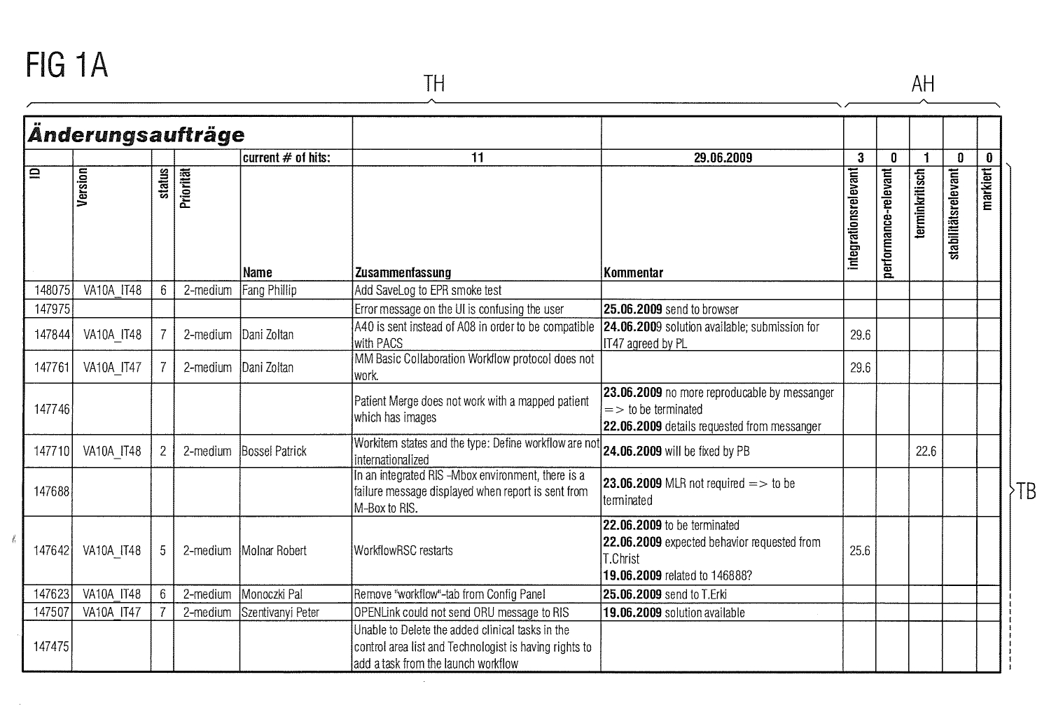

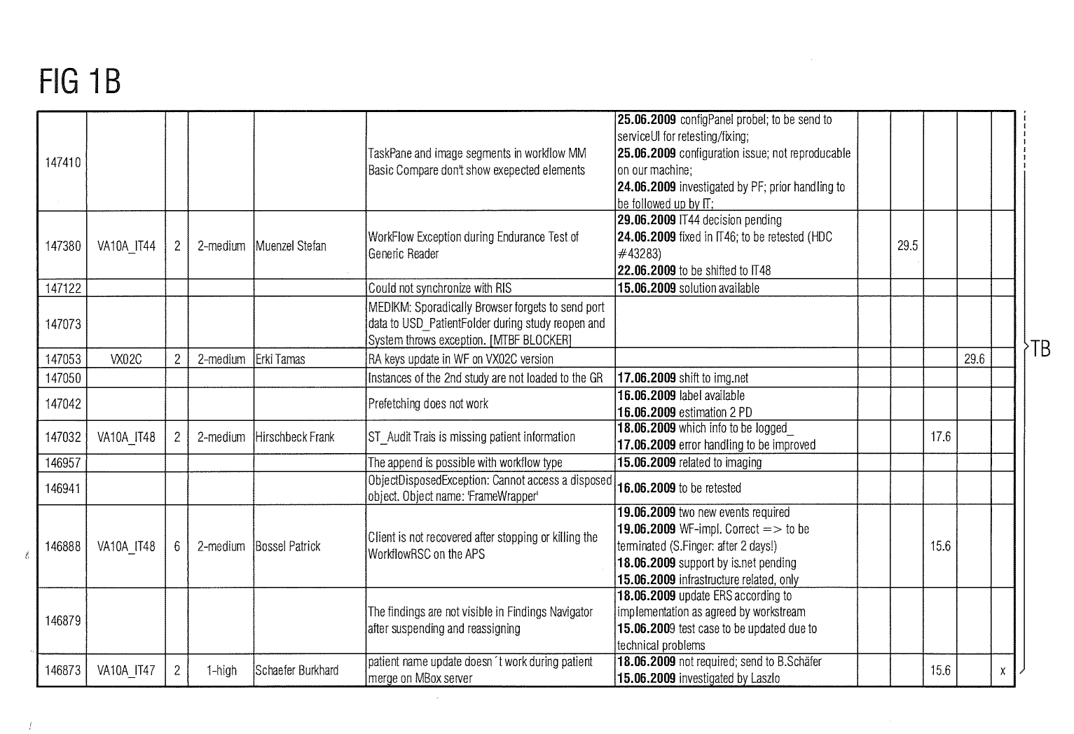

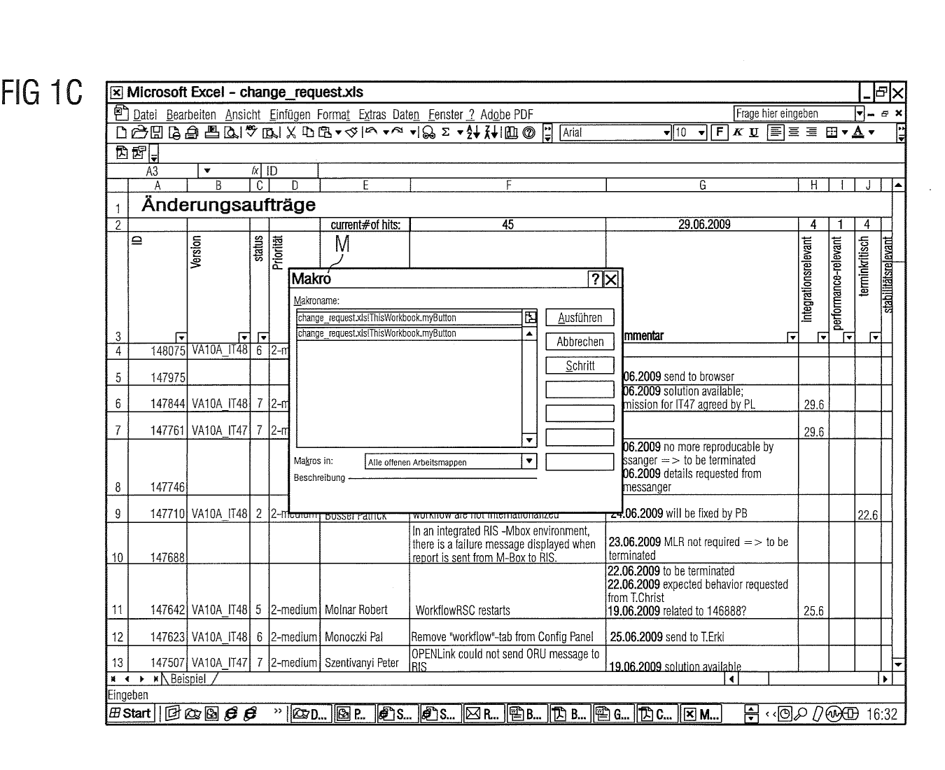

As shown in FIGS. 1a and 1b, to this end all important information of a change order is combined in a row of a table

Table Head TH (See Header in the Excel List)

This information is organized according to the columns

ID (identity)

Version

Status

Priority

Name

Summary

Comments

Furthermore, various, non-disjoint classifications are available here in an

integration-relevant

performance-relevant

time-critical

prioritized

marked

fashion for each order change according to the attributes Att.

Table Body TB (See the Body of the Excel List)

The referenced table shows a whole series of exemplary change orders.

Macro M (the Macro “myButton” in the Excel List)

The following functionalities are available by way of a macro, which is called up using the short cut <Strg><q> (=user control element), if the cursor
a) is located in the table header (table head as an example of an active selection element) of the following gap:

ID: all filters are repositioned and all non-empty table rows in column ‘ID’ are shown;

Version: all filters are repositioned and all non-empty table rows in column “Version” are shown;

Status: only the rows which have the value “2” in column “Status” are shown from the current filter result;

Priority: only the rows which have the value “6” in column “Status” are shown from the current filter result;

Comments: only the rows whose “Comments” field is empty are shown from the current filter result;

integration-relevant: all filters are repositioned and all non-empty table rows in the ‘integration-relevant’ column are shown;

performance-relevant: all filters are repositioned and all non-empty table rows in the ‘performance-relevant’ column are shown;

time-critical: all filters are repositioned and all non-empty table rows in the ‘time-critical’ column are shown;

stability-relevant: all filters are repositioned and all non-empty table rows in the ‘stability-relevant’ column are shown;

marked: all filters are repositioned and all non-empty table rows in the ‘marked’ column are shown;
b) The cursor is positioned in a table cell (table cell as an example of an active selection element) of the column:

ID: The selected entry is opened in the underlying data base;

Version: Only the rows, which have the same value in column “Version” as the cells which contain the cursor, are shown from the current filter result;

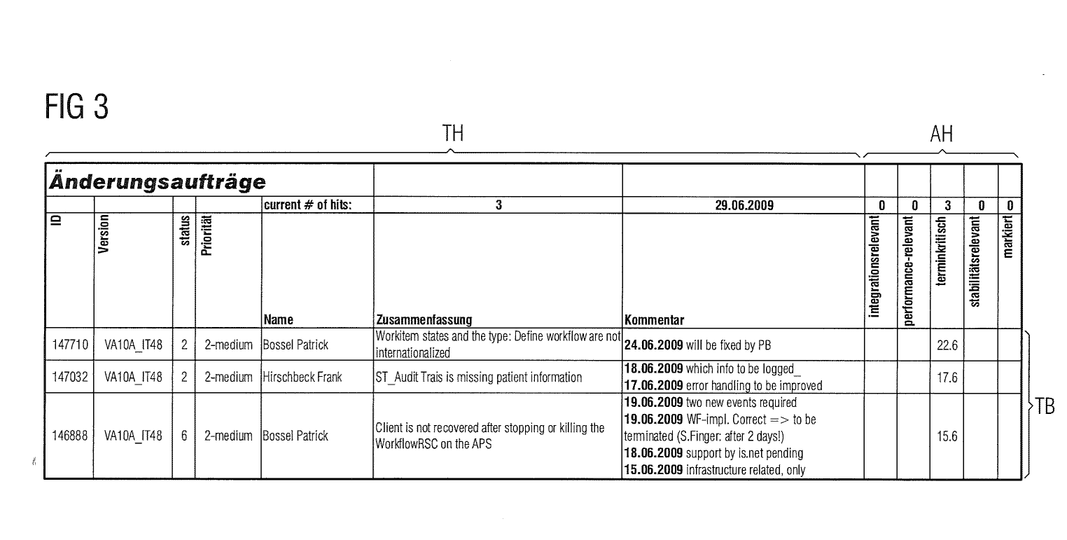

The described functionality can be reproduced by way of a short cut e.g. <strg><q> as a control element and an amendment file (see FIG. 3), if the execution of macros is permitted upon opening. (E.g. cells marked in a color, (e.g. ID and attribute ATT) in the header, indicate a filter, which includes the overall table; cells marked in another color, (e.g. table head TH without ID) visualize additional filters, which are only executed on the visible cells).

Furthermore, it is conceivable for the control element to be run in terms of hardware, e.g. as an extra key on the keyboard (similarly to the Windows key). This control element (“my button”) can then be individually occupied by the user—as described above, and thus contributes to a personalization of the user interface across all applications.

FIG. 3 shows exemplary data according to a time-critical application of an embodiment of the invention (table head), followed by ‘Version’=“VA10A_IT48” (table cell).

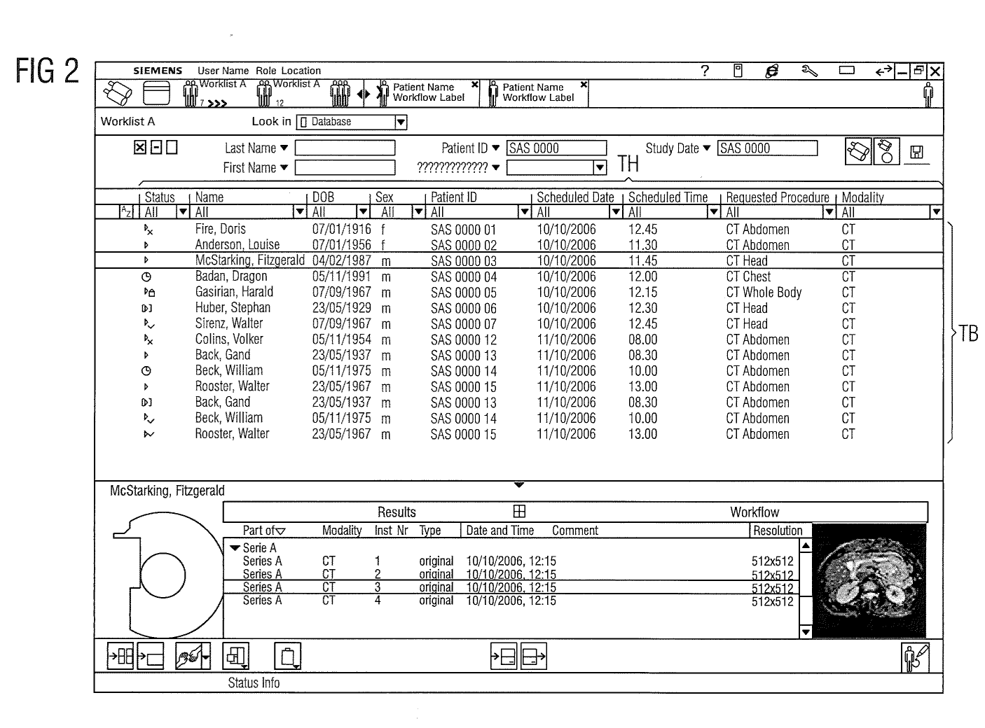

FIG. 2 shows by way of example a data organization in a medical environment on the basis of an application for displaying and processing patient examinations.

Table Head TH (See Header in the Browser Screenshot Shown in FIG. 2)

The list of the patients to be processed is organized according to the columns

Status

Name

Date of Birth (DOB)

Sex

Patient ID

Scheduled Date

Scheduled Time

Requested Procedure

Modality

Furthermore, result data (Results) and detailed information (Workflow) from the order list are available for the selected examination order.

Table Body TB (See Body in the Screen Shot)

The application shows a whole series of example patient examinations and their status and dates. Conceivable functionalities, if the cursor C
a) is located in the table head TH of the following column:

Status: all filters are repositioned and the examinations are sorted according to the basic setting;

Patient: all filters are repositioned and only those examinations are shown which are planned for the separate working environment;

Scheduled date: only those examinations which are planned for the current day (ascending sorting according to “scheduled time”) are shown from the actual filter result;

Modality: all filters are repositioned and only those examinations which are planned for the actual examination methods are shown;
b) The cursor is located in a table cell of the column:

Status: Only those examinations which have the same symbol in column “Status” as the cell, which contains the cursor, are shown from the current filter result;

Requested Procedure: detailed-information relating to the examination, which contains the cursor, is shown in the lower part of the table in the plan “Workflow” W;

Modality: the result data of the examination, which contains the cursor, is shown in the lower part of the table in the plan “Results” R;

Furthermore, it would also be conceivable to change between the representation of pre-examinations and current images when the functionality is called-up in the region of the result presentation (Results R).

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for providing a user control element within a computer-assisted data organization and storage system, comprising:
dynamically linking functionality of the user control element to at least one of context and semantics of an active selection element;
receiving a selection of at least one active selection element from a plurality of available selection elements; and
using the functionality linked to the selected at least one active selection element to trigger and provide the user control element.

2. The method as claimed in claim 1, wherein the functionality includes at least one of:
filtering,
sorting,
optical display,
fading-in of additional information, and
activation of assigned applications.

3. The method as claimed in claim 1, wherein at least one of the data organization and storage system is represented by at least one of a data list, table, database and archiving system.

4. A device, comprising:
a display module to provide a user control element within a computer-assisted data organization and storage system, functionality of the user control element being dynamically linked to at least one of context and semantics of an active selection element;
means for selecting at least one selection element from a plurality of available selection elements; and
means for using the functionality linked to the active, at least one selected selection element to trigger providing of the user control element.

5. The device as claimed in claim 4, wherein the functionality includes at least one of:
filtering,
sorting,
optical display,
fading-in of additional information, and
activation of assigned applications.

6. The device as claimed in claim 4, wherein at least one of the data organization and storage system is represented by at least one of a data list, table, a database, and archiving system.

7. The method as claimed in claim 2, wherein at least one of the data organization and storage system is represented by at least one of a data list, table, database and archiving system.

8. The device as claimed in claim 5, wherein at least one of the data organization and storage system is represented by at least one of a data list, table, a database, and archiving system.

9. A device, comprising:
a display module to provide a user control element within a computer-assisted data organization and storage system, functionality of the user control element being dynamically linked to at least one of context and semantics of an active selection element; and
at least one device to select at least one selection element from a plurality of available selection elements, the functionality linked to the selected at least one selected selection element being usable to trigger providing of the user control element.

10. The device as claimed in claim 9, wherein the functionality includes at least one of:
filtering,
sorting,
optical display,
fading-in of additional information, and
activation of assigned applications.

11. The display module as claimed in claim 9, wherein at least one of the data organization and storage system is represented by at least one of a data list, table, a database, and archiving system.

12. The display module as claimed in claim 10, wherein at least one of the data organization and storage system is represented by at least one of a data list, table, a database, and archiving system.

13. A display module to provide a user control element within a computer-assisted data organization and storage system, functionality of the user control element being dynamically linked to at least one of context and semantics of an active selection element, comprising:
at least one device to select at least one selection element from a plurality of available selection elements, the functionality linked to the selected at least one selected selection element being usable to trigger and provide the user control element.

14. The display module as claimed in claim 13, wherein the functionality includes at least one of:
filtering,
sorting,
optical display,
fading-in of additional information, and
activation of assigned applications.

15. The display module as claimed in claim 13, wherein at least one of the data organization and storage system is represented by at least one of a data list, table, a database, and archiving system.

16. The display module as claimed in claim 14, wherein at least one of the data organization and storage system is represented by at least one of a data list, table, a database, and archiving system.

17. A computer readable medium including program segments for, when executed on a computer device, causing the computer device to implement the method of claim 1.
